(19) United States
(12) Patent Application Publication
(10) Pub. No.: US 2013/0335966 A1
(43) Pub. Date: Dec. 19, 2013

(54) LIGHTING DEVICE

(71) Applicant: Kabushiki Kaisha Toshiba, Minato-ku (JP)

(72) Inventors: Masahiro YOKOTA, Fukaya-shi (JP); Osamu Ono, Fukaya-shi (JP); Ken Takahashi, Kumagaya-shi (JP); Shusuke Morita, Fukaya-shi (JP); Nobuo Kawamura, Kumagaya-shi (JP); Takeshi Ookawa, Kumagaya-shi (JP); Hideo Oota, Tokyo (JP); Hidemi Matsuda, Toda-shi (JP); Takashi Nishimura, Fukaya-shi (JP)

(73) Assignee: Kabushiki Kaisha Toshiba, Minato-ku (JP)

(21) Appl. No.: 13/972,319

(22) Filed: Aug. 21, 2013

Related U.S. Application Data
(63) Continuation of application No. PCT/JP2012/056163, filed on Mar. 9, 2012.

(30) Foreign Application Priority Data
Mar. 11, 2011 (JP) 2011-054342
Sep. 20, 2011 (JP) 2011-205334

(51) Int. Cl. F21K 99/00

(52) U.S. Cl. CPC F21K 9/52
USPC 362/235; 362/311.01; 362/294

(57) ABSTRACT

According to one embodiment, a lightning device includes a base member, a light source on the base member, a light guide body configured to guide at least part of light forwardly emitted from the light source. The light guide body includes an incident portion covering the front of at least the part of the light source, a bent light guide portion outwardly bent from the incident portion and configured to curvedly guide incident main light to the outside, and a light-emitting surface located on the distal end of the bent light guide portion, directly exposed to the outside of the device, and configured to emit the curvedly guided light laterally or rearwardly relative to the light source.

### CROSS REFERENCE TO RELATED APPLICATIONS

This application is a Continuation Application of PCT Application No. PCT/JP2012/056163, filed Mar. 9, 2012 and based upon and claiming the benefit of priority from Japanese Patent Applications No. 2011-054342, filed Mar. 11, 2011; and No. 2011-205334, filed Sep. 20, 2011, the entire contents of all of which are incorporated herein by reference.

### FIELD

Embodiments described herein relate generally to a lighting device using light sources with a narrow luminous-intensity distribution surface-mounted like a white light-emitting diode (LED).

### BACKGROUND

Although incandescent bulbs based on light emission by a heated filament have been widely used as lighting devices, they have had problems of short life, luminous efficiency, etc.

In recent years, LED light sources and EL (electroluminescence) light sources have been developed as technologies to solve these problems, and use of the LED light sources, in particular, for conventional lighting devices have been exponentially spread.

In general, the external shape of an LED bulb is defined by a cap attached to a metallic base member and a hemispherical light-transmitting cover, and a mounting substrate mounted with an LED light source in a position corresponding to the center of the sphere of the light-transmitting cover is attached to the base member. The light source is caused to emit light through a drive circuit in the base member by electricity supplied through the cap.

Light from the light source mounted on the mounting substrate has such directivity that the luminous intensity is attenuated in proportion to cos θ, where θ is an angle between the normal direction of the mounting substrate and light strongly emitted normal to the mounting substrate. This is because the conventional LED light source is configured so that an LED chip that emits a primary light beam is covered flat by a protective layer containing a phosphor that converts the primary light beam into a secondary light beam. Thus, a lighting device using an LED light source for a bulb or fluorescent lamp has such a luminous-intensity distribution that light normal to the mounting substrate is strong and hardly any light is emitted laterally or rearwardly relative to the mounting substrate. If a conventional incandescent bulb or fluorescent lamp that has a substantially uniform luminous-intensity distribution from front to back is replaced with the lighting device using the LED light source, therefore, the brightness of the ceiling and walls is inevitably greatly changed, resulting in a differently illuminated space.

A technique in which LEDs that constitute a light source are laterally and rearwardly disposed in a three-dimensional manner is proposed as a technique to solve the problem of the narrow luminous-intensity distribution. As another technique, moreover, there is a technique in which the inner surface of a light-transmitting cover is coated with a phosphor that can be excited by light from an LED light source, whereby the light-transmitting cover itself glows. Still another technique is proposed in which a light source is disposed at the lower end of a spherical light-transmitting cover. There is still another technique in which a light guide body is installed near an LED light source.

If an LED light source is mounted three-dimensionally, there are problems that the manufacture and assembly of a lighting device are complicated and the difficulty of the design for mechanical strength and heat dissipation inevitably increases. Also if a phosphor is applied to a light-transmitting cover, there is a problem that the manufacture and assembly of the lighting device are complicated. If the light source is disposed at the lower end of a spherical light-transmitting cover, a base member is made shorter or smaller than the overall length restriction of the lighting device, so that heat radiation is inevitably degraded and fails to produce a large amount of heat. If a light guide body is installed, moreover, the prior art techniques can provide neither a sufficient luminous-intensity distribution control function nor a natural design.

### BRIEF DESCRIPTION OF THE DRAWINGS

FIG. 1 is a sectional view showing an LED bulb according to a first embodiment;

FIG. 2 is a sectional view showing an LED bulb according to a first modification;

FIG. 3 is a sectional view showing an LED bulb according to a second modification;

FIG. 4 is a sectional view showing an LED bulb according to a third modification;

FIG. 5 is a sectional view showing an LED bulb according to a fourth modification;

FIG. 6 is a sectional view showing an LED bulb according to a fifth modification;

FIG. 7 is a sectional view showing an LED bulb according to a sixth modification;

FIG. 8 is a sectional view showing an LED bulb according to a seventh modification;

FIG. 9 is a sectional view showing an LED bulb according to an eighth modification;

FIG. 10 is a sectional view showing an LED bulb according to a ninth modification;

FIG. 11 is a sectional view showing an LED bulb according to a tenth modification;

FIG. 12 is a sectional view showing an LED bulb according to an eleventh modification;

FIG. 13 is a sectional view showing an LED bulb according to a twelfth modification;

FIG. 14 is a sectional view showing an LED bulb according to a thirteenth modification;

FIG. 15 is a sectional view showing an LED bulb according to a fourteenth modification;

FIG. 16 is a sectional view of the LED bulb taken along line A-A of FIG. 15;

FIG. 17 is a sectional view showing an LED bulb according to a fifteenth modification;

FIG. 18 is a sectional view showing an LED bulb according to a sixteenth modification;

FIG. 19 is a sectional view showing an LED bulb according to a seventeenth modification;

FIG. 20 is a sectional view showing an LED bulb according to a second embodiment;

FIG. 21 is a plan view showing a positional relationship between a light guide body and light sources of the LED bulb according to the second embodiment;

FIG. 22 is a plan view showing another positional relationship between the light guide body and light sources of the LED bulb according to the second embodiment;

FIG. 23 is a plan view showing an LED bulb according to a modification of the second embodiment; and

FIG. 24 is a sectional view showing a fluorescent-lamp-type lighting device according to a third embodiment.

### DETAILED DESCRIPTION

Various embodiments will be described in detail with reference to drawings. In general, according to one embodiment, a lighting device comprises: a base member; a light source disposed on a front portion of the base member; and a light guide body provided covering at least part of the light source and configured to guide at least part of light forwardly emitted from the light source. The light guide body comprises an incident portion covering the front of at least the part of the light source, a bent light guide portion outwardly bent from the incident portion and configured to curvedly guide incident main light to the outside, and a light-emitting surface located on the distal end of the bent light guide portion, directly exposed to the outside of the device, and configured to emit the curvedly guided light laterally or rearwardly relative to the light source.

### First Embodiment

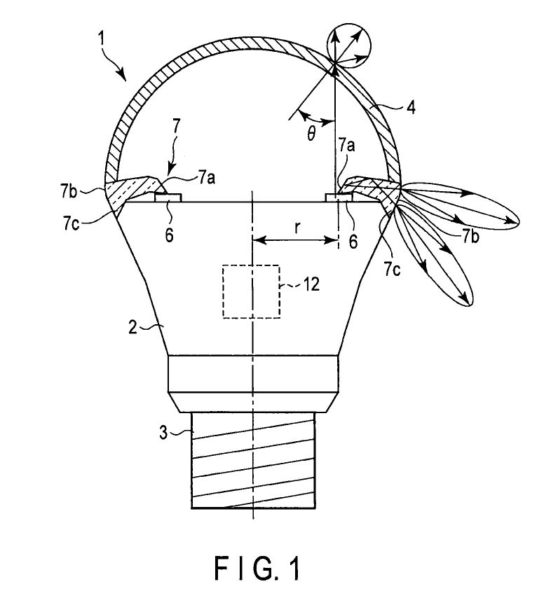

FIG. 1 is a sectional view showing an LED bulb 1 for use as a bulb-type lighting device according to a first embodiment. The LED bulb 1 has a shape rotationally symmetrical with respect to a central axis.

The LED bulb 1 comprises a base member 2, a plurality of light sources 6, light-transmitting cover 4, light guide body 7, and cap 3. The light sources 6 are formed of LEDs. The light-transmitting cover 4 is formed of a substantially hemispherical milk-white member. The light guide body 7 is formed of a substantially ring-shaped transparent member and comprises a luminous emission section that emits light between the base member 2 and light-transmitting cover 4.

The base member 2 serves both as a metallic housing and as a heat radiating member and comprises a flat top portion (front portion). The light sources 6 are mounted on the top portion. The top portion on which the light sources 6 are mounted is coated with a white paint to prevent absorption loss of light. A drive circuit 12 is accommodated in the base member 2 and its periphery has the function of radiating heat produced in the light sources 6 and the drive circuit.

The plurality of light sources 6 are arranged in a ring, e.g., in a circular or polygonal shape, in a position eccentric to the center of the base member 2 by r. Thus, the luminous-intensity distribution is spread in such a manner that intense light emitted normal to the light sources 6 is obliquely incident when it reaches the light-transmitting cover 4. Preferably, the eccentricity r should be set so that an angle θ between the direction normal to the facing light-transmitting cover 4 and the direction normal to the light sources is 10° or more.

The light guide body 7 is a ring-shaped member of, for example, polycarbonate and integrally comprises a ring-shaped light-incident portion 7a provided at least partially covering the light sources 6, a light-emitting portion 7b extending radially outwardly from the light-incident portion, and a fixed portion 7c, which is secured to the base member 2. The light-emitting portion 7b comprises a light-emitting surface directly exposed to the outside of the LED bulb 1, and this light-emitting surface is located between the light-transmitting cover 4 and base member 2 and directed laterally and rearwardly relative to the light sources 6. Further, the light-emitting surface is continuous with the outer surface of the light-transmitting cover 4 and, along with the light-transmitting cover, constitutes a light-emitting surface of the LED bulb 1.

The light guide body 7 takes in forwardly directed light through the light-incident portion 7a that partially covers the respective upper surfaces of the light sources 6, bends it in the light guide body 7, and emits the light rearwardly or laterally from the light-emitting surface of the light-emitting portion 7b. The light-emitting surface of the light-emitting portion 7b is inclined so that its normal line is rearwardly directed to facilitate rearward emission. The light-emitting portion 7b and fixed portion 7c of the light guide body 7 are adjoined to the light-transmitting cover 4 and base member 2 so that the light-emitting surface of the light-emitting portion 7b and the light-transmitting cover 4 or base member 2 describe a smooth continuous curve, whereby the individual parts are sealed and secured.

The light-transmitting cover 4 that serves as a cover member is a hemispherical member of, for example, milk-white polycarbonate, which is disposed covering the light sources 6 and light guide body 7 and the lower end of which is secured to the base member 2 with the light-emitting portion 7b of the light guide body 7 therebetween. The transmittance of the light-transmitting cover 4 is set as low as 60%. This serves to sufficiently diffuse light forwardly emitted from the light sources 6 that are not covered by the light guide body 5 and to discharge it to the outside. Glare sensation is mitigated by enlarging the luminous-intensity distribution and glossing the entire light-transmitting cover 4 to hide the light sources 6, as well as by means of the above-described eccentricity of the light sources 6.

The LED bulb 1 constructed in this manner can provide advantages in luminous-intensity distribution control, heat radiation control, compactness, and mass-productivity.

First, in the luminous-intensity distribution control, part of the light forwardly emitted from the light sources 6 is caused to emerge rearwardly by the light guide body 7, so that the luminous-intensity distribution can be easily widened. Since the Fresnel reflection is used in the light guide through the light guide body 7, moreover, the loss is so small that a high efficiency can be maintained. Since the light is guided from the inside light-incident portion 7a toward the outside light-emitting portion 7b, in particular, it can be easily emitted with a rearwardly or laterally narrowed luminous-intensity distribution, so that wide luminous-intensity distribution control that is not achievable by the conventional light-guide technology is possible. According to this embodiment, an average luminous intensity of 50% or more can be maintained even just behind the bulb and a wide luminous-intensity distribution substantially equivalent to that of an incandescent bulb can be obtained.

Then, in the heat radiation control, it is hardly necessary to make the base member 2 compact, since the vertical width of the light-emitting portion 7b is very small, as small as 4 mm. Therefore, other parts than the substantially hemispherical light-transmitting cover 4 and light guide body 7 can be used for the volume of the base member 2, so that a space can be secured for the installation of a heat sink system and radiator system, and there is no burden imposed by heat radiation. Thus, compactification of the LED bulb 1 can be achieved at the same time. In the embodiment, the LED bulb 1 is 75 mm high and 36 mm wide, substantially conforming to the outer diameter of a conventional mini-krypton incandescent bulb and also conforming to the luminous-intensity distribution, as described above.

Mass production requires no special process despite the use of the light guide body 7 as an additional part, due to the availability of a conventional white LED and other parts. The light guide body 7 can be manufactured with high mass-productivity by injection molding processes.

According to the present embodiment, moreover, the surface of the light guide body 7 is grained, so that the interior can be prevented from being seen through the light guide body 7 and the difference in texture from the light-transmitting cover 4 is reduced. For the surface treatment of the light guide body 7, the inner surface may be coated with a dispersing agent or two-color-molded so that light can be taken out through it. Alternatively, hiding and enlargement of the luminous-intensity distribution may be achieved by doping a transparent material itself with a certain amount of diffusion filler.

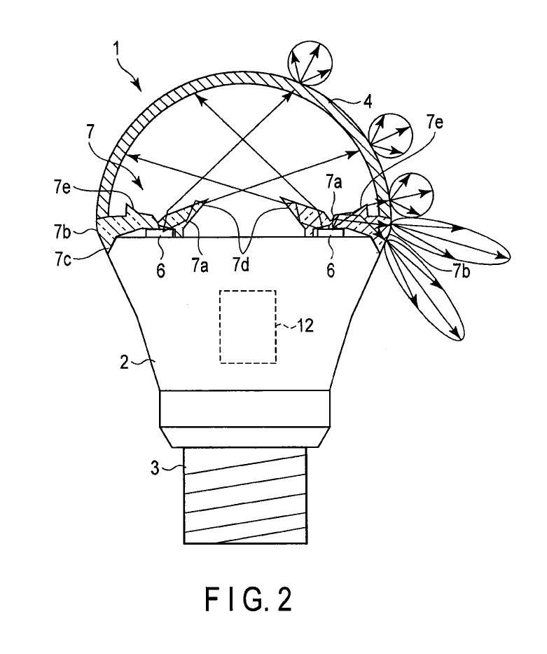

FIG. 2 shows an LED bulb 1 according to a first modification of the first embodiment.

In this modification, a light guide body 7 further comprises an inner-surface light-emitting portion 7d extending inwardly and upwardly from a light-incident portion 7a and an auxiliary light-emitting portion 7e extending obliquely upward from an intermediate portion of a light-emitting portion 7b. The light-incident portion 7a is configured to cover the entire forward emitting portions of a plurality of light sources 6.

The inner-surface light-emitting portion 7d obliquely diffuses light directed to a light-transmitting cover 4, so that the luminance does not become uneven even if the transmittance of the light-transmitting cover 4 is increased to 75%. Thus, the efficiency is improved by the increase in the transmittance of the light-transmitting cover 4. The auxiliary light-emitting portion 7e secondarily emits light to that part of the light-transmitting cover 4 which adjoins the light guide body 7 and is shaded by the light guide body 7 so that the luminance is reduced. In this way, the luminance of the entire light-transmitting cover 4 is equalized.

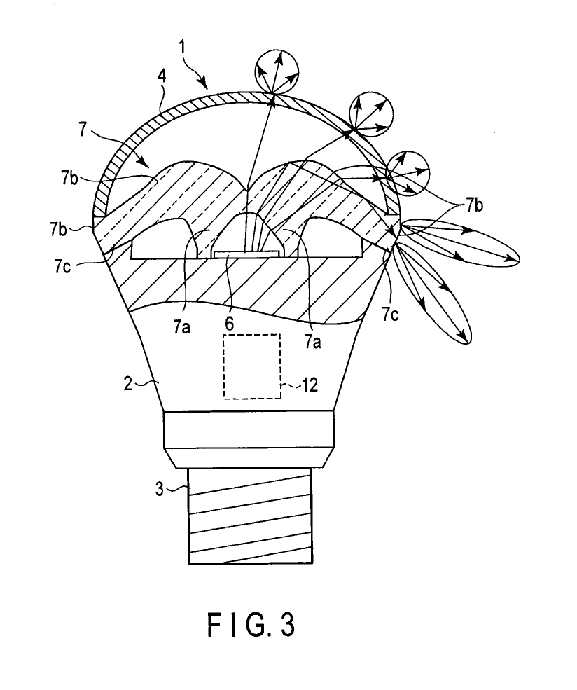

FIG. 3 shows an LED bulb 1 according to a second modification of the first embodiment.

In this case, a light source 6 is disposed on the central axis of a base member 2. A light guide body 7 is in the form of a disk covering the entire top portion of the base member 2, and the outer peripheral portion of the light guide body forms a light-emitting portion 7b that emits light with a luminous-intensity distribution overemphasized rearwardly and laterally. Further, the light guide body 7 comprises a front-side light-emitting portion 7b that forwardly emits light. Since the light should also be forwardly emitted in a balanced way, a certain amount of diffusion filler (not shown) is mixed in the light guide body 7, whereby light can also be forwardly emitted throughout the light guide body 7.

Since light emitted from the light guide body 5 has an overemphasized light distribution on the front side, moreover, a milk-white light-transmitting cover 4 in the form of a flat hemisphere is installed there for an improved appearance. Thus, the light emitted from the light guide body 7 can be diffused so that the entire light-transmitting cover 4 glows regardless of the viewing angle.

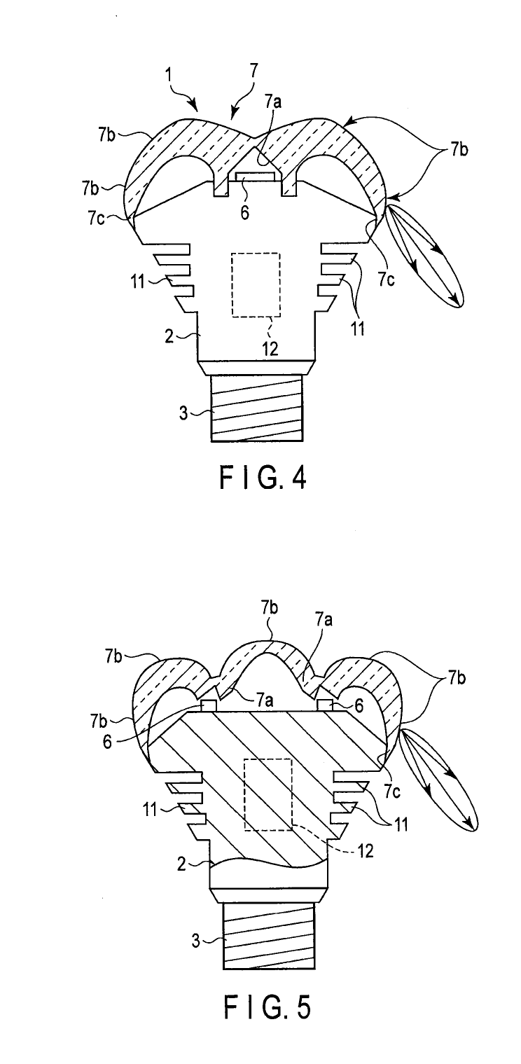

FIG. 4 shows an LED bulb 1 according to a third modification of the first embodiment.

To pursue efficiency, the third modification is configured so that a milk-white light-transmitting cover 4 is deleted, and a light guide body 7 is configured to serve also as a light-transmitting cover 4 as a light source protective cover. To improve the heat radiation function, the light guide body 7 is formed into a flat disk, which covers the entire top portion of a base member 2. The radiator function is improved by giving the greater part of the volume of the bulb to the base member 2 and providing radiator fins 11 by means of a generous space in the base member 2. In the present modification, an omni-directional light bulb with brightness of about 60 W and efficiency of 94% is achieved.

FIG. 5 shows an LED bulb 1 according to a fourth modification of the first embodiment.

According to the present modification, a plurality of light sources 6 are arranged in a ring, e.g., in a circular shape, on the top portion of a base member 2, in the foregoing third modification. In this case, a light-incident portion 7a of a light guide body 7 is in the form of a ring covering the plurality of light sources 6.

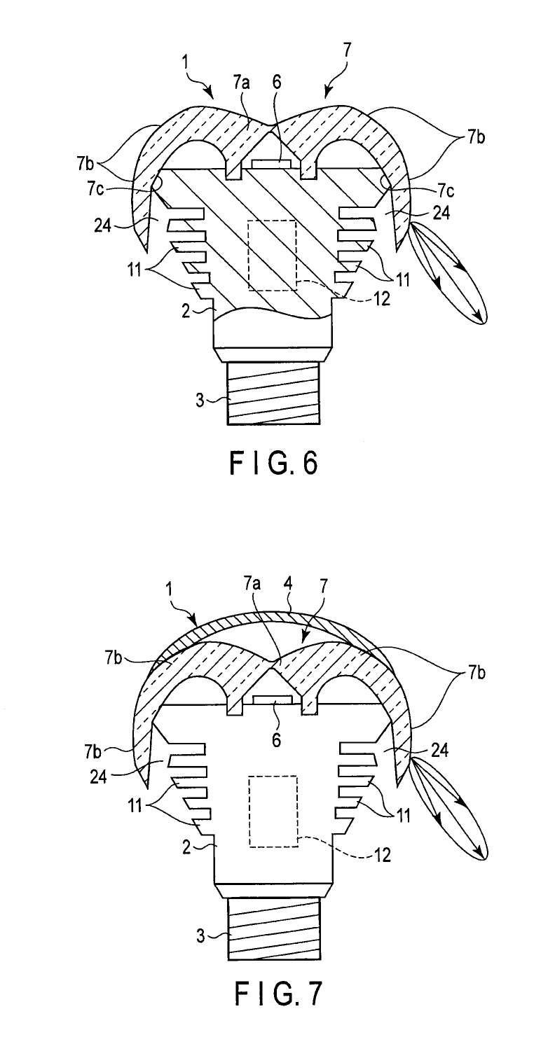

FIG. 6 shows an LED bulb 1 according to a fifth modification of the first embodiment.

According to the present modification, a light-emitting portion 7b of a light guide body 7 is rearwardly extended to increase a light-emitting area so that the appearance resembles that of an incandescent bulb, in the foregoing third modification. At the back of a sealed fixed portion 7c of the light guide body 7, moreover, a heat radiation space 24 for air convection is provided between the light-emitting portion 7b and base member 2, whereby the light-emitting area is increased and the heat radiation function is improved.

FIG. 7 shows an LED bulb 1 according to a sixth modification of the first embodiment.

In the present modification, a light-transmitting cover 4 is further added to the LED bulb 1 according to the fifth modification shown in FIG. 6. The light-transmitting cover 4 is a milk-white member lower in transmittance than the light guide body 7 and has the effects of further improving the evenness of luminance and presenting a bulb-like appearance.

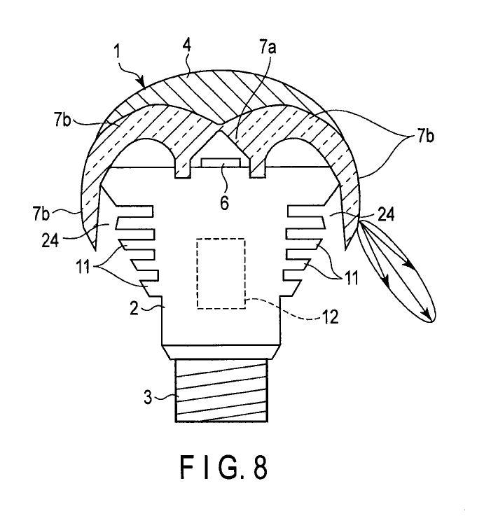

FIG. 8 shows an LED bulb 1 according to a seventh modification of the first embodiment.

In the present modification, the light-transmitting cover 4 of the LED bulb 1 according to the foregoing sixth modification is integrally formed with a light guide body 7 by two-color injection molding. Since the light-transmitting cover 4 is lower in transmittance than the light guide body 7, a moderate light guide function remains so that the above-described light guide effect can be obtained even though the light-transmitting cover and light guide body 7 are integrally formed.

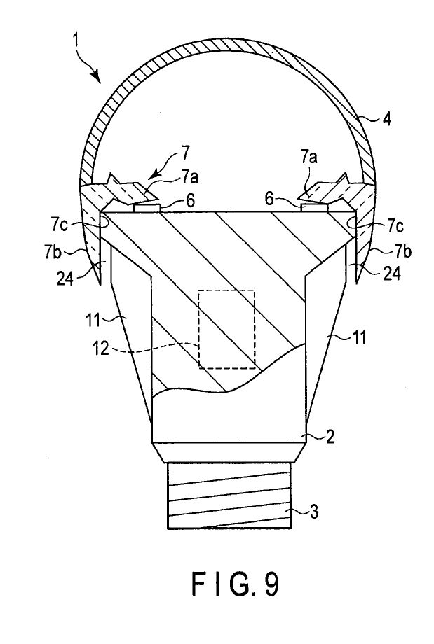

FIG. 9 shows an LED bulb 1 according to an eighth modification of the first embodiment.

According to the present modification, a plurality of radiator fins 11 are provided on the outer peripheral surface of a base member 2. The radiator fins 11 radially extend from the base member 2 and are arranged at predetermined circumferential intervals. A light-emitting portion 7b of a light guide body 7 extends from the top portion of the base member 2 to the back side of a fixed portion 7c of the light guide body and extends outwardly relative to the radiator fins 11. This light-emitting portion 7b is in the form of a ring concentric with the central axis of the base member 2 and is located outside the radiator fins 11 with a heat radiation space 24 between itself and the radiator fins 11. Thus, a heat radiation function is reconciled with the increase of a light-emitting area. Also, the evenness of luminance is improved by means of a light-transmitting cover 4.

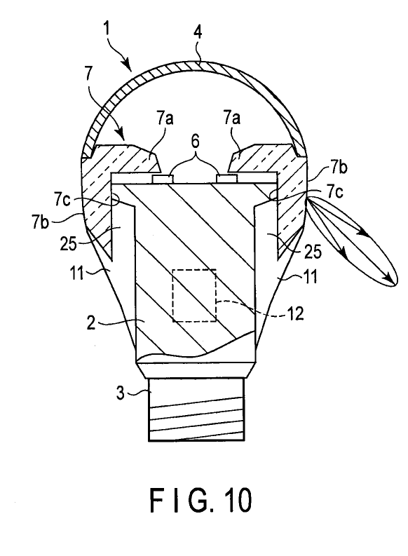

FIG. 10 shows an LED bulb 1 according to a ninth modification of the first embodiment.

While the ninth modification, like the eighth modification of FIG. 9, is also intended to increase a light-emitting area, a light-emitting portion 7b of a light guide body 7 is configured to partially extend to the back side and be inserted between radiator fins 11 so that the light-emitting area is increased. Also in this case, a heat radiation space 25 for air convection is provided between a base member 2 and the light-emitting portion 7b at the back of a fixed portion 7c of the light guide body 7, so that a heat radiation function is reconciled with the increase of the light-emitting area. Also, the evenness of luminance is improved by means of a light-transmitting cover 4.

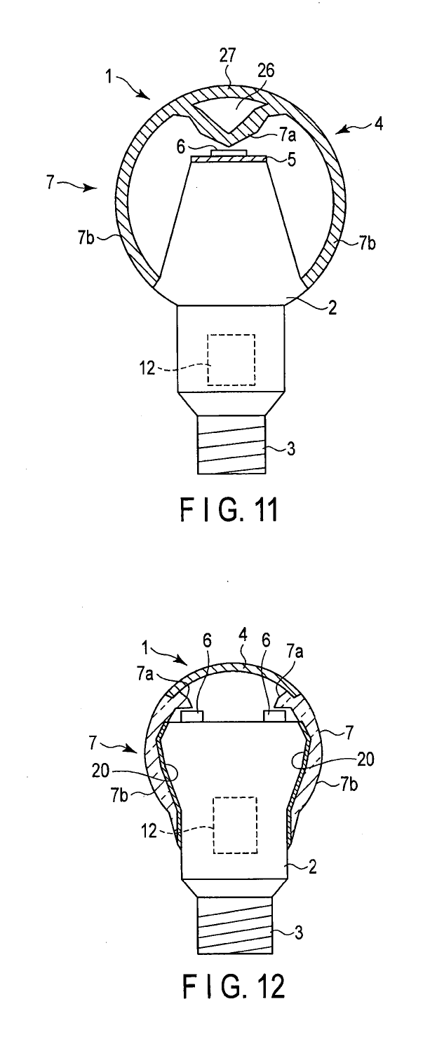

FIG. 11 shows an LED bulb 1 according to a tenth modification of the first embodiment.

In the present modification, a milk-white light-transmitting cover 4 is not used, and a light guide body 7 is made of a material doped with a certain amount of diffusion filler. Further, the light guide body 7 is substantially spherical and comprises a light-incident portion 7a such that a hollow portion 26 facing a light source 6 is formed in its front center. A dummy light guide body 27 made of the same material as the light guide body 7 is welded to the light guide body 7 so as to cover the hollow portion 26. Thus, the luminous-intensity distribution is increased while maintaining a smooth external appearance.

FIG. 12 shows an LED bulb 1 according to an eleventh modification of the first embodiment.

In this case, a base member 2 is set to be long, light sources 6 are located in front of it, and a sufficient volume and accommodation space are ensured for a heat sink and a drive circuit 12, respectively. The light guide body 7 comprises a light-incident portion 7a facing at least part of each light source 6, e.g., a half of the upper surface of each light source, and a light-emitting portion 7b extending close to a cap 3 along the outer periphery of the base member 2 from the light-incident portion to the back side of the light source position. The light-emitting portion 7b is formed in such a manner that its outer peripheral portion forms a spherical surface. The light guide body 7, especially the inner surface of the light-emitting portion 7b, is bonded to the adjacent base member 2 with a silicone adhesive 20 and contacts the base member 2. Thus, heat produced in the base member 2 is efficiently transferred to the light guide body 7 and radiated to the outside through the light guide body 7.

The light guide body 7 has such a shape that its internal space is bulging and cannot be easily injection-molded as an integral part. Actually, therefore, the light guide body 7 is assembled from two or three vertically divided parts. Naturally, if a reduction in mass-productivity due to an increased thickness is allowed, the light guide body may be formed of an integral part the internal space of which is not bulging but cylindrical.

A light-transmitting cover 4 is formed covering the top portion of the light guide body 7 so that its surface outline is spherical.

Thus, the entire area of the spherical body can be caused to glow like an incandescent bulb while maintaining a high heat radiation function.

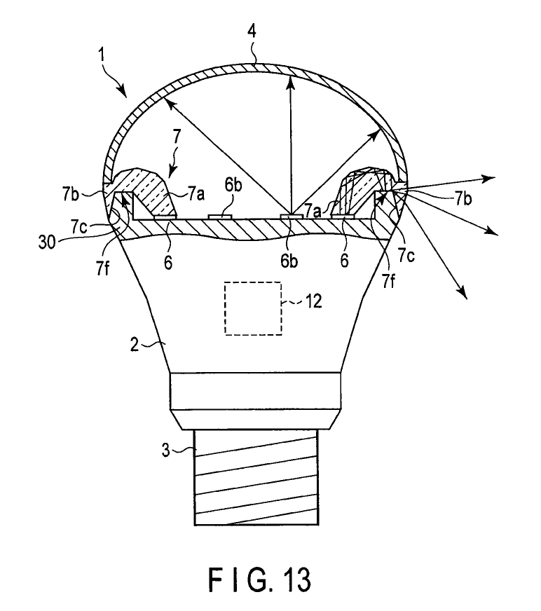

FIG. 13 shows an LED bulb 1 according to a twelfth modification of the first embodiment.

According to the present modification, a base member 2 integrally comprises a ring-shaped projection 30 forwardly projecting from the peripheral edge portion of its upper surface. On the upper surface of the base member 2, a plurality of light sources 6 configured to laterally or rearwardly emit light by means of a light guide body 7 are arranged in a circular shape coaxial with the base member 2. Further, a plurality of light sources 6b for frontal irradiation are newly provided inside the light sources 6.

The light guide body 7 is provided bridging over the projection 30 of the base member 2. Specifically, the light guide body 7 integrally comprises a ring-shaped light-incident portion 7a provided covering at least part of the light sources 6, a light-emitting portion 7b radially outwardly extending from the light-incident portion, bridging over the projection 30, and a fixed portion 7c secured to the base member 2. Further, a reversely-bent light guide portion 7f that is outwardly open is formed inside the light-emitting portion 7b of the light guide body 7. Thus, light that is applied from the light sources 6 to the light guide body 7 and curvedly guided to the back side is further oppositely curvedly guided so that it can be widely emitted, ranging from the lateral sides to the back side.

The projection 30 of the base member 2 serves to increase the surface area of the base member 2 for radiating heat to the air, thereby preventing the base member 2 from being heated even when high power is supplied. Since the projection 30 is formed adjacent to the inside of the light guide body 7, it also has the function of reflecting light inwardly leaking from the light guide body 7.

Since the dedicated light sources 6b for frontal irradiation are provided inside the light sources 6 that are arranged in a circular shape, the amount of frontal light can be arbitrarily controlled. The light sources 6 arranged in a circular shape can be used as dedicated light sources for emitting curvedly guided and laterally or rearwardly directed light.

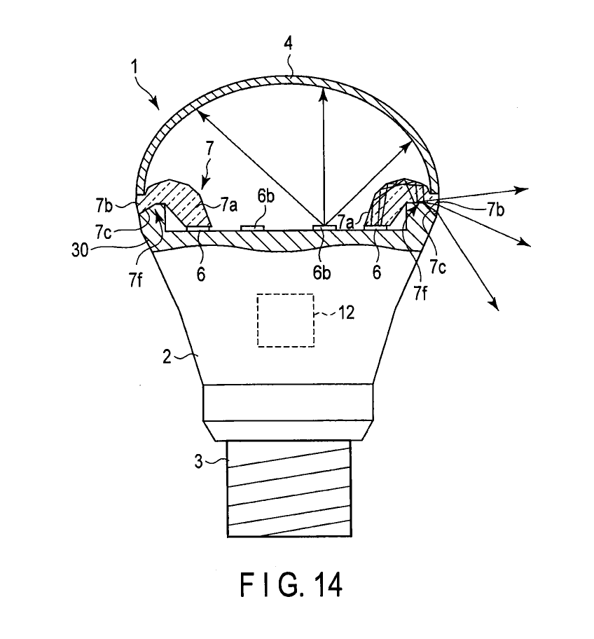

In the twelfth modification, the light-emitting portion 7b of the light guide body 7 is configured to cover the outside of the projection 30 of the base member 2, in order to increase the light-emitting area. As in a thirteenth modification shown in FIG. 14, however, the light-emitting portion 7b may be configured so that its area is restricted to a minimum.

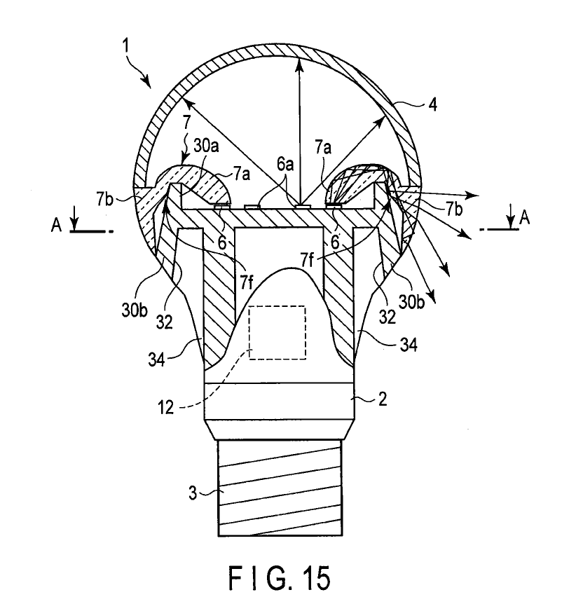

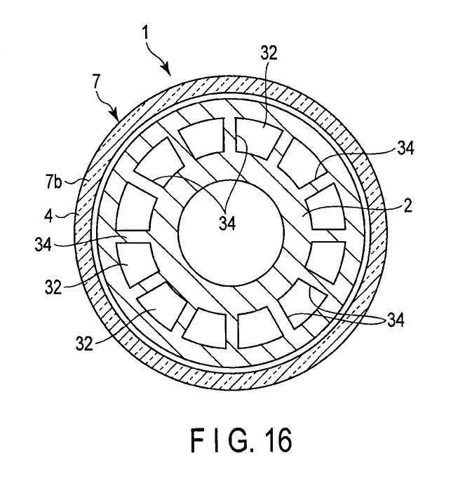

FIGS. 15 and 16 show an LED bulb 1 according to a fourteenth modification of the first embodiment. According to the fourteenth modification, a light-emitting portion 7b of a light guide body 7 is rearwardly extended to a position at the back of light sources 6 such that its apparent light-emitting area is increased for an attractive appearance. A base member 2 integrally comprises a ring-shaped forward projection 30a forwardly projecting from its peripheral edge portion and a ring-shaped back projection 30b projecting in a planar direction from the peripheral edge portion. The forward projection 30a is located inside the light guide body 7 and serves to enhance the heat radiation function of the base member 2. The light-emitting portion 7b bridges over the forward projection 30a and extends to the outside of the forward projection 30a and back projection 30b.

A vacant space in the back projection 30b forms a hollow portion 32 for air convection, and a plurality of radially extending radiator fins 34 are arranged in the hollow portion 32 such that they also serve to fix the external appearance of the bulb.

The light guide body 7 comprises a reversely-bent light guide portion 7f disposed inside the light-emitting portion 7b so that the distribution of light emitted with a uniform luminance distribution from the light-emitting portion 7b spreads. Thus, rearwardly curvedly guided light is reversely curvedly guided by the reversely-bent light guide portion 7f so that it can be widely emitted, ranging from the lateral sides to the back side.

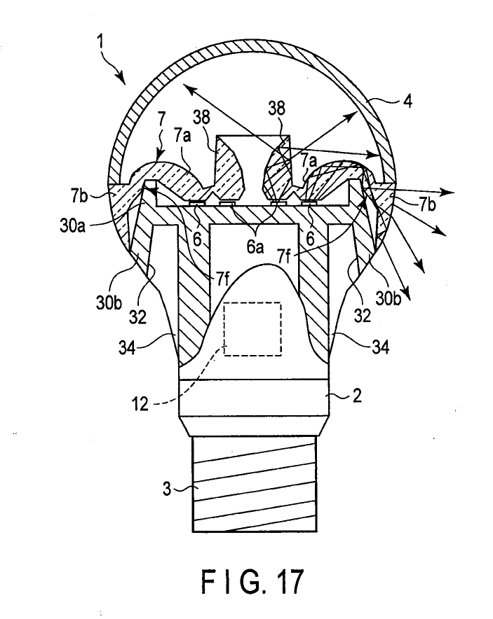

Light sources 6a for frontal irradiation are provided inside the light sources 6 arranged in a circular shape facing the ring-shaped light guide body 7. As regards the frontal light sources 6a, as in a fifteenth modification shown in FIG. 17, a frontal-diffusion light guide portion 38 facing the light sources 6a may be provided on a light guide body 7, whereby too strong light is laterally diffused and a light-transmitting cover 4 is made to glow uniformly.

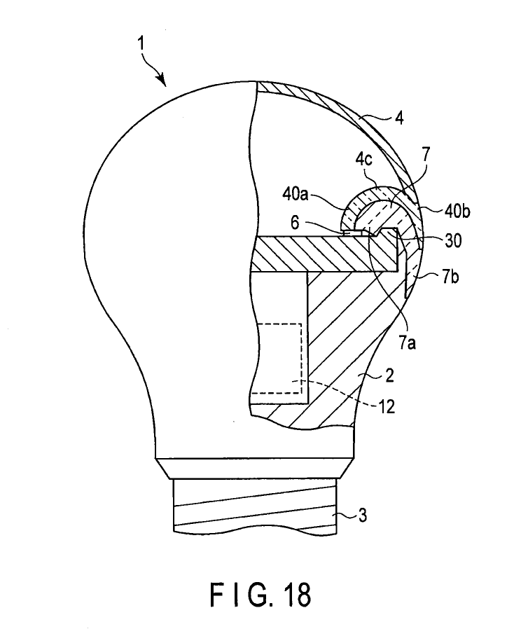

FIG. 18 shows an LED bulb 1 according to a sixteenth modification of the first embodiment. According to the sixteenth modification, a second light guide body 40 is superposed on the above-described light guide body 7. Specifically, the two light guide bodies 7 and 40 are provided in layers facing light sources for lateral/rearward irradiation. The second light guide body 40, like the light guide body 7, comprises a light-incident portion 40a partially facing light sources 6 and a light-emitting portion 40b extending radially outwardly from the light-incident portion, bridging over a projection 30. A light-emitting surface of the light-emitting portion 40b is exposed to the outside of the electrode 1.

The interface between the superposed light-incident portion 7a and second light guide body 40 increases as a refractive interface that guides light from the light sources 6 to the back side, so that light can be guided to the light-emitting portions 7b and 40b without a further frontal leakage. As both the respective light-emitting surfaces of the light guide bodies 7 and 40 are exposed to the outside, as in the present modification, an improvement in efficiency and increase in the amount of rearward light are facilitated.

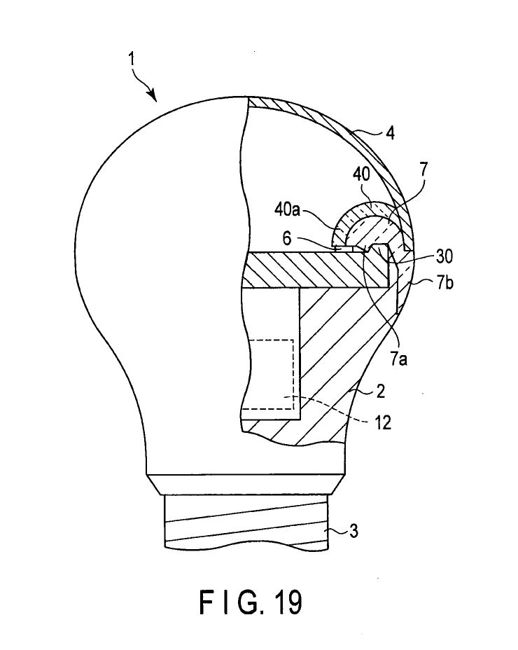

As in a seventeenth modification shown in FIG. 19, a light-emitting portion 40b of a second light guide body 40 may be confined inside a light-transmitting cover 4 without being exposed to the outside. In this case, the interface between a light guide body 7 and the second light guide body is not exposed to the outside, so that the external appearance of a bulb 1 can be improved.

Although, for example, a structure for taking out light from the light guide body has not been particularly mentioned in connection with the first embodiment and the various modifications described above, the take-out structure may be provided based on joining of grains and diffusion members. The number of the light sources may be increased or decreased as required. The light-transmitting cover is not limited to a spherical or elliptical shape and may be formed in another shape. Although the LED bulb has been described herein, moreover, the invention may also be applied to street lighting based on a combination of a directional light source and a light-transmitting cover that surrounds the light source substantially in a sphere, or alternatively, an EL light source may be used.

In connection with the second to fifteenth modifications, like reference numbers are used to designate the same portions as those of the first embodiment or the same portions as those of the other modifications, and a detailed description thereof is omitted.

The following is a description of lighting devices according to alternative embodiments. In the description of the alternative embodiments to follow, like reference numbers are used to designate the same portions as those of the foregoing first embodiment, and a detailed description thereof is omitted.

### Second Embodiment

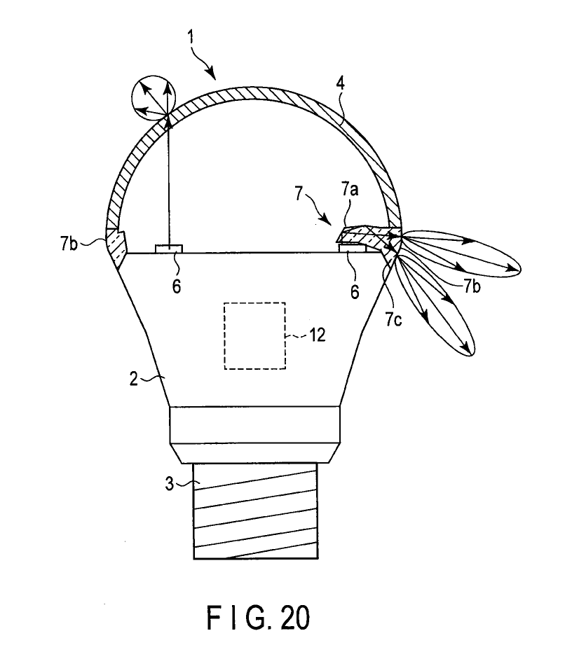

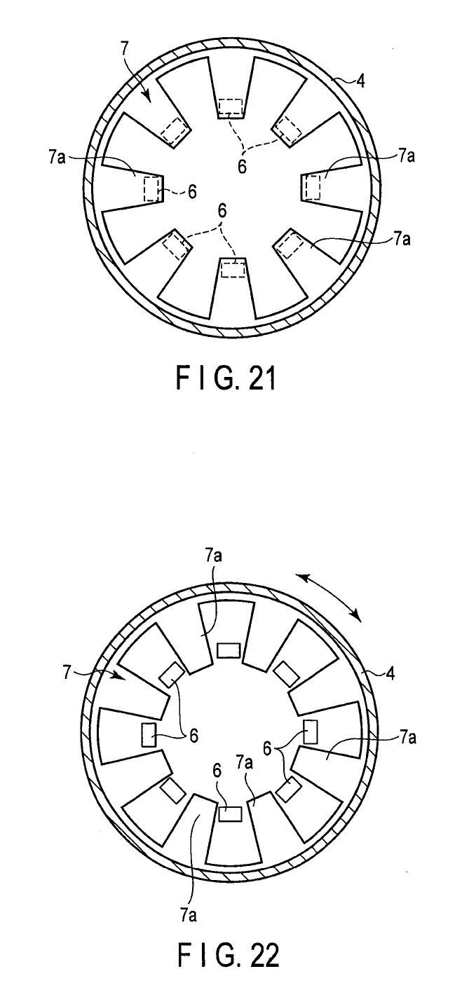

FIG. 20 is a sectional view showing an LED bulb 1 according to a second embodiment, FIG. 21 is a plan view showing a positional relationship between a light guide body and light sources, and FIG. 22 is a plan view showing another positional relationship between the light guide body and light sources. The basic configuration of the LED bulb 1 is the same as that of the first embodiment.

In the second embodiment, as shown in FIGS. 20 and 21, light-incident portions 7a of a light guide body 7 are partially notched to form a plurality of light-incident portions arranged spaced at equal circumferential intervals. Further, the light guide body 7 is mounted on a base member 2 for pivoting motion about its central axis. The relative position of the light-incident portions 7a and light sources 6 can be changed by pivoting the light guide body 7. In the present embodiment, the light sources 6 and light-incident portions 7a are equal in number and also in circumferential intervals of arrangement.

In the pivotal position shown in FIG. 21, each light-emitting portion 7b of the light guide body 7 is located overlapping its corresponding light source 6. In this pivotal position, most of light emitted from the light sources 6 is guided by the light guide body 7 and emitted laterally and rearwardly relative to the LED bulb 1 from the light-emitting surface of the light guide body 7, so that the resulting luminous-intensity distribution is suitable for lighting equipment such as an upward light lamp, which is mainly based on rearward light distribution.

As the light guide body 7 is pivoted through a predetermined angle, as shown in FIG. 22, moreover, each light-emitting portion 7b is shifted relative to the light sources 6 and located between its corresponding two adjacent light sources. In this pivotal position, most of light emitted from the light sources 6 is emitted directly forward, so that the resulting luminous-intensity distribution is suitable for lighting equipment such as a spot light, which irradiates only a specific forward region.

Thus, with the pivotal positions of FIGS. 21 and 22 regarded as two extreme pivotal positions, a user can adjust the luminous-intensity distribution of the LED bulb 1 to each lighting equipment by continuously adjusting the pivotal position of the light guide body 7, that is, the relative position of the light guide body and light sources, between those pivotal positions.

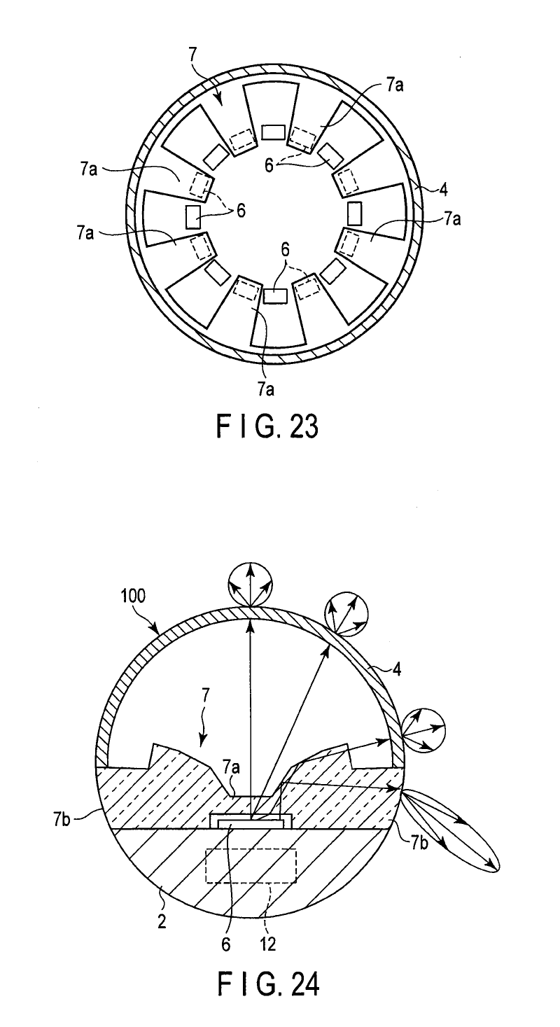

In the second embodiment, the light sources 6 and light-incident portions 7a are made equal in number. Alternatively, however, the light sources 6 may be made greater in number than (e.g., twice as many as) the light-incident portions 7a, as shown in FIG. 23. Without regard to the pivotal position of the light guide body 7, in this case, the light-incident portions 7a at least partially overlap the light sources 6, and at the same time, the light sources are at least partially dislocated relative to the light-incident portions 7a. Thus, lateral and rearward irradiation by the light guide body 7 and forward irradiation based on direct emission from the light sources can be achieved without regard to the pivotal position.

### Third Embodiment

FIG. 24 is a sectional view showing a lighting device according to a third embodiment.

In the present embodiment, the lighting device of the fluorescent-lamp type, not of the bulb type, is constructed.

A fluorescent lamp 100 comprises a linear elongated base member 2, light source 6, light guide body 7, and light-transmitting cover 4. The light source 6 is formed of a plurality of LEDs mounted at linear intervals on the top portion of the base member 2. The light guide body 7 is provided on the base member 2 so as to cover the light source 6. The light-transmitting cover 4 has a substantially spherical cross-section and is configured to cover the light guide body 7. The base member 2, light guide body 7, and light-transmitting cover 4 are formed so that the entire cross-sectional shape is circular, that is, the external appearance is the same as that of an existing fluorescent lamp.

The light guide body 7 comprises a light-incident portion 7a located opposite the light source 6 and light-emitting portions 7b laterally extending to opposite sides from the light-incident portion, the light-emitting portions 7b each comprising a light-emitting surface directly exposed in the outer surface of the fluorescent lamp 100. This light-emitting surface is curved so that its normal line is rearwardly directed. The light guide body 7 curvedly guides part of light forwardly radiated from the light source 6 and emits rearwardly or laterally strongly modulated light through the respective light-emitting surfaces of the light-emitting portions 7b.

Thus, a wide luminous-intensity distribution that is not achievable by a conventional LED fluorescent lamp can be achieved. The present embodiment may be configured by combining various elements of the foregoing first and second embodiments.

Also in the second and third embodiments described above, as in the foregoing first embodiment, there can be provided a lighting device capable of lateral or rearward irradiation, easy to manufacture, and having a high heat radiation function.

The present invention is not limited directly to the embodiments described above, and at the stage of carrying out the invention, its constituent elements may be embodied in modified forms without departing from the spirit of the invention. Further, various inventions can be formed by appropriately combining the constituent elements disclosed in the above-described embodiments. For example, some constituent elements may be deleted from all the constituent elements shown in the embodiments. Furthermore, constituent elements of different embodiments may be combined as required.

Although, for example, a structure for taking out light from the light guide body has not been particularly mentioned, the take-out structure may be provided based on joining of grains and diffusion members, or light to be taken out may be scattered by a certain amount of diffusion filler mixed in the very material that constitutes the light guide body. The number and type of the light sources are not particularly specified, and the action of the present invention is applicable to any light sources that have strong forward directivity. Although the light guide body is secured to the base member according to the embodiments, moreover, it may alternatively be secured to the light-transmitting cover.

Although the LED bulb has been described according to the embodiments, furthermore, the invention may also be applied to street lighting based on a combination of a directional light source and a light-transmitting cover that surrounds the light source substantially in a sphere, or alternatively, an EL light source may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A lighting device comprising:
a base member;
a light source disposed on a front portion of the base member; and
a light guide body provided covering at least part of the light source and configured to guide at least part of light forwardly emitted from the light source,
the light guide body comprising an incident portion covering the front of at least the part of the light source, a bent light guide portion outwardly bent from the incident portion and configured to curvedly guide incident main light to the outside, and a light-emitting surface located on the distal end of the bent light guide portion, directly exposed to the outside of the device, and configured to emit the curvedly guided light laterally or rearwardly relative to the light source.

2. The lighting device of claim 1, comprising a plurality of light sources, the plurality of light sources being arranged side by side in a circle.

3. The lighting device of claim 2, wherein the plurality of light sources are arranged so that an additional light source is disposed inside the light sources arranged side by side in a circle.

4. The lighting device of claim 2, wherein light emitted from those light sources of the plurality of light sources which are arranged side by side in a circle enters the light guide body and is emitted laterally and rearwardly, and light emitted from the light source disposed inside the circle is mainly emitted forwardly and laterally.

5. The lighting device of claim 1, wherein the light-emitting surface of the light guide body comprises a region with a rearwardly inclined normal line.

6. The lighting device of claim 1, further comprising a cover member provided in front of the light guide body, wherein the cover member and the light-emitting surface exposed to the outside of the light guide body form a continuous light-emitting surface.

7. The lighting device of claim 6, wherein the light-emitting surface is substantially hemispherical or in the shape of a flat hemisphere.

8. The lighting device of claim 7, wherein the cover member is made of a milk-white material higher in diffusibility than the light guide body.

9. The lighting device of claim 6, wherein the cover member and the light guide body are arranged partially overlapping each other.

10. The lighting device of claim 6, wherein the cover member and the light guide body are integrally molded without a gap.

11. The lighting device of claim 1, wherein the light guide body comprises a forward light-emitting portion configured to emit light forwardly relative to the light source.

12. The lighting device of claim 1, wherein the light-emitting surface of the light guide body extends along the base member to the back side of the light source position.

13. The lighting device of claim 1, wherein the base member comprises a heat radiation system inside a region extending to the back side of the light guide body.

14. The lighting device of claim 13, wherein the base member comprises a forward projection forwardly projecting from a peripheral edge portion of a top portion on which the light source is provided.

15. The lighting device of claim 14, wherein the light guide body comprises a light-emitting portion bridging over the forward projection of the base member and extending to the back side of the distal end of the forward projection.

16. The lighting device of claim 14, wherein the light guide body comprises a reversely-bent light guide portion configured to outwardly curvedly guide and rearwardly deflect incident light from the light source, reversely curvedly guide the rearwardly deflected light in a direction opposite to the direction of curvature, and laterally and rearwardly emit the light.

17. The lighting device of claim 14, wherein the light guide body is constructed by combining a plurality of light guide bodies.

18. The lighting device of claim 17, wherein the light guide body is constructed by laminating a plurality of light guide bodies.

19. The lighting device of claim 1, wherein the light guide body is in the form of a ring or a disk.

20. The lighting device of claim 1, wherein a surface of the light guide body is grained.

21. The lighting device of claim 1, wherein a surface of the light guide body is coated with a dispersing agent.

22. The lighting device of claim 1, wherein the light guide body is made of a material doped with a dispersing agent.

23. The lighting device of claim 1, wherein the light guide body is hermetically secured to the base member outside the light source.

24. The lighting device of claim 1, wherein the relative position of the light guide body and the light source is changeable.

25. The lighting device of claim 1, wherein the lighting device is a bulb-type lighting device.

26. The lighting device of claim 1, wherein the lighting device is a fluorescent-lamp-type lighting device.
